(19) United States
(12) Patent Application Publication
(10) Pub. No.: US 2005/0125554 A1
(43) Pub. Date: Jun. 9, 2005

(54) Method and apparatus for adaptive two-dimension inter-packet header compression

(75) Inventor: Oliver Keren Ban, Austin, TX (US)

Correspondence Address: International Business Machines;Intellectual Property Law, 11400 Burnet Road, Austin, TX, 78758, US

(73) Assignee: International Business Machines Corporation, Armonk, NY (US)

(21) Appl. No.: 10/727,321

(22) Filed: Dec. 3, 2003

(51) Int. Cl. G06F 15/173

(52) U.S. Cl. 709/238

(57) ABSTRACT

A method and apparatus for an adaptive two-dimension inter-packet header compression for faster and more efficient transmission of a broadcasting packet. Currently, uneven speeds exist between the originator and the final receptors because certain router paths are slower than the rest of the other pathways, limiting the overall performance to the performance of the slowest pathways. This current art results in bottlenecks at certain routers, causing the overall speed of transmission to be slowed. The present invention is directed to optimizing the slowest and least efficient routers, so that the bottlenecks that currently exist in the current art of transmitting broadcasting packets are eliminated. This is achieved through the temporary storage of the broadcasting payload in a coded header inside broadcasting routers. The coded header is transmitted to a receiving server, and its corresponding broadcasting payload is transmitted to the coded header, to form a full broadcasting packet at the receiving server.

### TECHNICAL FIELD

The present invention relates to network broadcasting packets transmitted between communication networks such as the World Wide Web (Web) and display terminals, and particularly between broadcasting servers, such as routers.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or distributed packet switched network. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web. Also, as a result of the rapid expansion of the Web, E-mail, multimedia files and documents and real-time digital broadcastings, which have been distributed for over 25 years over smaller private and specific purpose networks, has moved into distribution over the Web because of the vastly improved server technology and channels that are available. We have seen that server and compression technology has been growing exponentially but the channel capacity has grow relatively slowly compared with server technology, especially with regard to the uneven access channels that existed in the vastly distributed internet world. For example, the speed gaps between the backbone and end terminals become wider and wider as time passes.

Switched packets are provided from a Web distribution site which is usually made up of one or more server computers that communicate with packet formatted information between the distributed web formatted server. This communication usually relates from one server in response to one or more users' requests sent over the Web through a server handshake protocol on the requester's receiving server station. As in broadcasting modes, significant Web distribution sites are made up of many coordinated server computers and associated databases. Such significant Web distribution sites usually serve large institutions, such as corporations, universities, retail stores or governmental agencies. These distribution sites may also provide to smaller businesses or organizations support for and distribution of individual Web pages created, owned and hosted by the individual small businesses and organizations.

There are other factors that affect the overall performance and capacity of the web. Despite the substantial technological advancements made in recent years in the data transfer capacity (bandwidth) of communication networks, as well as the increasing capacity of storage systems, communication networks are having difficulty in keeping up with the rapidly increasing demand for more bandwidth and more storage capacity on the Web and associated private communication networks.

Because of the complexity of Web distribution sites, it is costly and time consuming to access Web documents or broadcasting packets through the complexity of servers and databases at the Web distribution sites. Accordingly, it has long been the practice at such sites to maintain distribution site caches that temporarily store recently accessed Web documents at a forward distribution point with respect to the Web, so as to avoid the cost and time of re-accessing such documents from the databases. Because of the increased Web usage, such cache storage facilities have been overburdened.

Similarly, there are great demands on packet switching distribution facilities. One of the more common current protocols for accessing and facilitating packet switching involves broadcast servers. The service provider for the user receiving/sending display station provides a broadcast server that is characterized by a similar series of the vast quantity of packets that it handles. Thus, it is sending series of packets to many different notes through the same backbone channels or through many different speed channels. The receiver's server then resends the packets in its own network until it reaches its final destination. In this process, many headers have been added in or stripped from the packets payload between the server and the user terminal.

Conventional Web distribution site server systems, as well as service providers maintaining the packet broadcast and distribution servers, have little control of the compression and extent of the headers that the creators of the packets or Web pages put into the channels. Consequently, electronic media and document distribution networks are seeking implementations that conserve the bandwidth and storage capacity requirements of electronic documents being transmitted over communication networks.

The availability of extensive packets computational compressed channels has made it possible to keep all necessary parties in business, government and public organizations completely informed of all transactions that they need to know about at almost nominal costs. Such communication can also include broadcasting packets that are time consuming to download because a bottleneck is created in certain routers or broadcasting servers. A router is an intermediary device on a communication network that expedites message delivery. A broadcasting packet is a unit of information transmitted as a whole from one device to another on a network.

Often, a message-delivery technique referred to as “packet switching” occurs in which small units of information are relayed through stations in a computer network along the most efficient route available between the sender and receiver. A packet-switching network handles information in small units, breaking long messages into multiple packets before routing. These multiple packets that make up the full broadcasting packet are referred to herein as “broadcasting payload”. While each payload may travel a different route, and the payload may arrive at the receiver at different times or out of sequence, the receiver's system reassembles the original broadcasting packet/message correctly.

Currently, uneven speeds exist between the originator and the final receptors because certain router paths are slower than the rest of the other pathways, limiting the overall performance to the performance of the slowest pathways. In other words, a chain is only as strong as its weakest link, and in this case, the overall performance of sending a broadcasting packet is only as fast as the slowest router pathway. The present invention is directed to strengthening the “weakest links” or optimizing the slowest and least efficient routers, so that the bottlenecks that currently exist in the current art of transmitting broadcasting packets are eliminated.

### SUMMARY OF THE PRESENT INVENTION

The present invention provides a method and apparatus for fast communication over the Web via servers with broadcasting packets. The present invention allows a user in a communication network for packet distribution between data processor controlled interactive display terminals, including a sending terminal and a receiving terminal, to route broadcasting packets from a sending server to a receiving server by temporarily storing a broadcasting payload inside a broadcasting router as a coded header. As used herein, the broadcasting payload refers to the parts of the broadcasting packet that separate for transmission of the broadcasting packet to later reassemble and form a full broadcasting packet. The coded header of the broadcasting payload is then transmitted to the receiving server via the broadcasting router, and transmits a corresponding document/payload to its coded header to form a full broadcasting packet in the receiving server.

The present invention is particularly useful to users of a computer system who send large broadcasting packets and who want to send the broadcasting packets more quickly and more efficiently.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the interactive display terminals, as well as servers in the Internet or Web packets distribution of this invention;

FIG. 2 is a generalized view of a packet distribution system in a Web or Internet that may be used in the practice of the present invention;

FIG. 3 is a diagrammatic illustration of an interactive display interface used for the writing of a packet document with a broadcasting packet; and

FIG. 4 is an illustrative flowchart describing the setting up of the functions to route a broadcasting packet via a router by temporarily storing a broadcasting payload inside the broadcasting router as a coded header and transmitting the coded header to form a full broadcasting packet in the receiving server.

### DETAILED DESCRIPTION OF THE PREFERRED EMBODIMENT

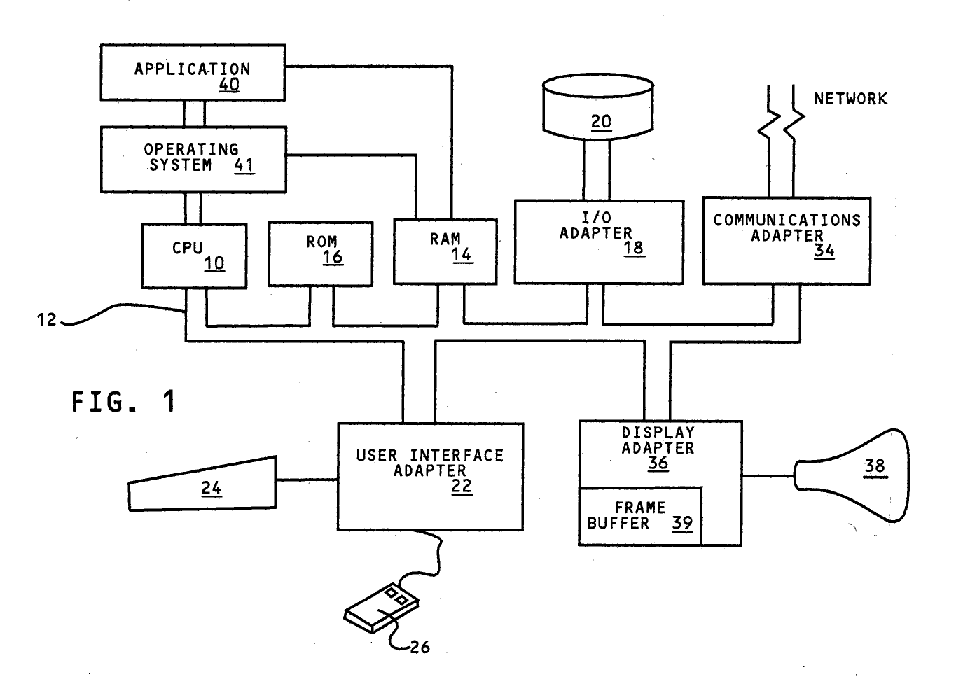

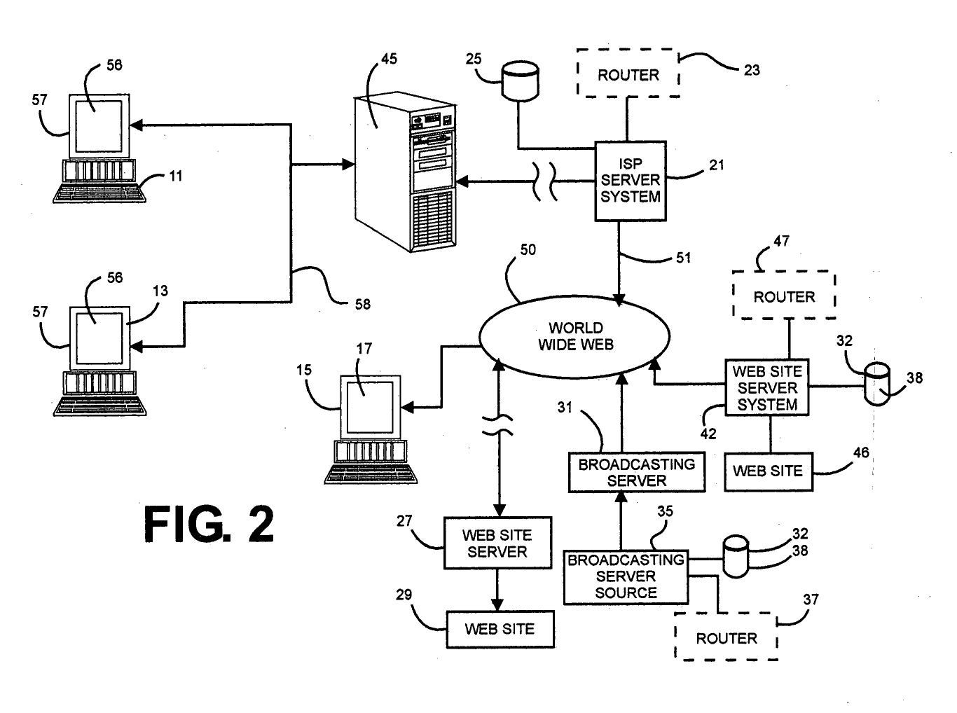

Referring to FIG. 1, a typical data processing system is shown which may function as the computer network terminal or Web station used conventionally as any of the sending or receiving Web stations for electronic mail transmission; the system shown is also illustrative of any of the server computers used for the Web packet distribution to be described in greater detail with respect to FIG. 2.

A central processing unit (CPU) 10, may be one of the commercial microprocessors in personal computers available from International Business Machines Corporation (IBM) or Intel Corporation; when the system shown is used as a server computer at the Web distribution site, to be subsequently described, then a workstation is preferably used, e.g. RISC System/6000™ (RS/6000) series available from IBM. The CPU 10 is interconnected to various other components by system bus 12. An operating system 41 runs on a CPU 10, provides control and is used to coordinate the functions of the various components of FIG. 1. Operating system 41 may be one of the commercially available operating systems such as IBM's AIX 5L™ operating system; Microsoft's Windows XP™; or Windows2000™, as well as other UNIX and AIX operating systems. Application programs 40, controlled by the system, are moved into and out of the main memory Random Access Memory (RAM) 14. These programs include the programs of the present invention for adaptive two dimensional inter packet header compression resulting in a faster and more efficient method of transmitting a broadcasting packet to a receiving terminal via a broadcasting router by temporarily storing the broadcasting payload inside a broadcasting router as a coded header. Where the computer system shown functions as the receiving Web station, then any conventional Web browser application program, such as Microsoft's Internet Explore™, will be available for accessing packets from the Web and for sending packets to the Web from the network station. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to access Web documents. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to documents packets and broadcasting packets transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. Digital packets are distributed through such a network.

A generalized diagram of a portion of the Web for illustration of the packets distribution system of the present invention is shown in FIG. 2. The computer controlled display terminals 11 and 13 have displays 57 upon which packets 56 may be created by senders and displayed. Terminals 11 and 15 may be implemented by the computer system set up in FIG. 1, and connection 58 (FIG. 2) is the network connection shown in FIG. 1. Reference may be made to the above-mentioned Mastering the Internet, pp. 136-147, for typical connections between local display stations to the Web via network servers, any of which may be used to implement the system on which this invention is used. In the typical set up shown, terminals are connected via, for example, host dial connections (not shown) to server 45 provided by a Web Service Provider system 21 that in turn accesses the Web 50 via connection 51. This connection 51 is a backbone wide band connection. A backbone, as used herein, refers to the smaller networks that perform the bulk of the packet switching of Internet communication.

For the purpose of this embodiment, packets is created on either terminal 11 or 13, and sent via a narrow channel 58 over the Web 50 to receiving terminal 15. The Web Service Provider system 21 that may be based upon the POP (Post Office Protocol) system manages the distribution of these packets, as well as the distribution of other electronic documents and broadcasting packets. Whether the Web Service Provider uses the POP system with its sparse storage capacity or other network distribution systems, storage capacity for the system present a definite problem. The server system 21 stores the in/out electronic documents of its clients at stations like 11 and 13 in storage facilities 25 of limited capacity. A key to the present invention is the separate temporary storage of the coded header of the broadcasting payload in the broadcasting routers 23, 37, and 47, which is then transmitted to the receiving server via the broadcasting routers 23, 37, and 47. The corresponding document of the broadcasting payload is transmitted to form a full broadcasting packet in the receiving server. This is illustrated in FIG. 2 wherein the routers 23, 27, and 47 are shown. In FIG. 2, there is illustrated a packet document or broadcasting packet being transmitted by a sender, e.g. packet on sending terminal 13 as shown in FIG. 2. The broadcasting packet is sent to a broadcasting router 23, 37, and 47 via a broadcasting server 31 that temporarily stores the broadcasting payload 32 of the broadcasting packet in a coded header 38. This occurs by temporarily coding the broadcasting payload 32 to a set of symbols, temporarily stripping the broadcasting payload 32 from the broadcasting packet, and temporarily replacing the broadcasting packet with a coded symbol and adding the coded symbol to the header 38. The sending terminal 13 is able to transmit these coded headers 38 to the receiving terminal 11, where the broadcasting payload 32 is retrieved from storage and the coded header 38 is patched to the corresponding broadcasting payload 32. The broadcasting payload 32 is relayed to a destination router according to its address. The present invention allows a user to more quickly and more efficiently transmit broadcasting packets without encountering the bottlenecks in the routing of such transmissions that currently exist.

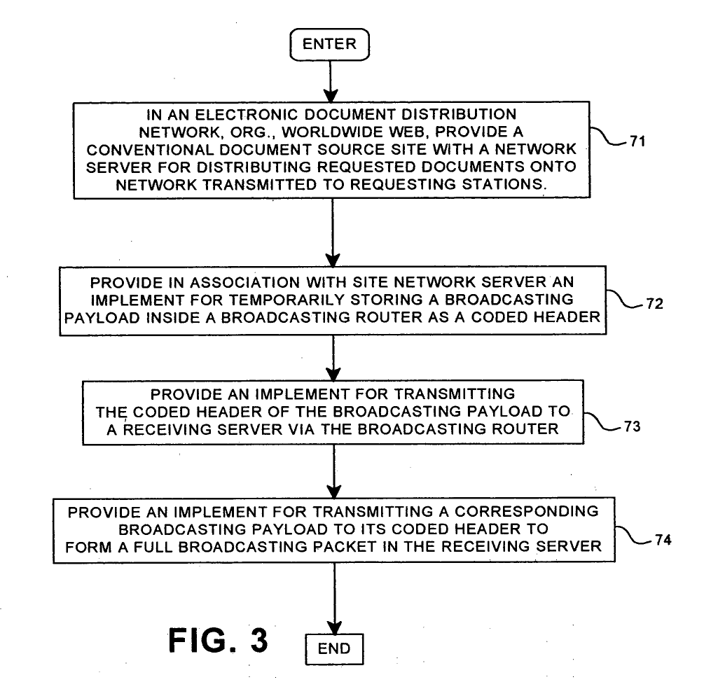

FIG. 3 is a flowchart showing the development of a process according to the present invention for enabling senders of a broadcasting packet to more quickly and more efficiently transmit the broadcasting packet via routers by temporarily storing a broadcasting payload of the broadcasting packet in a coded header. In an electronic document distribution network, such as the Web, there is provided a conventional document source site with a network server for distributing on to the Web, documents requested by Web stations, step 71. There is provided, in association with one or more network site servers, an implementation for temporarily storing a broadcasting payload inside a broadcasting router as a coded header, step 72. Also provided is an implementation for transmitting the coded header of the broadcasting payload to a receiving server via the broadcasting router, step 73. Finally, an implementation is provided for transmitting a corresponding broadcasting payload to its coded header to form a full broadcasting packet in the receiving server, step 74.

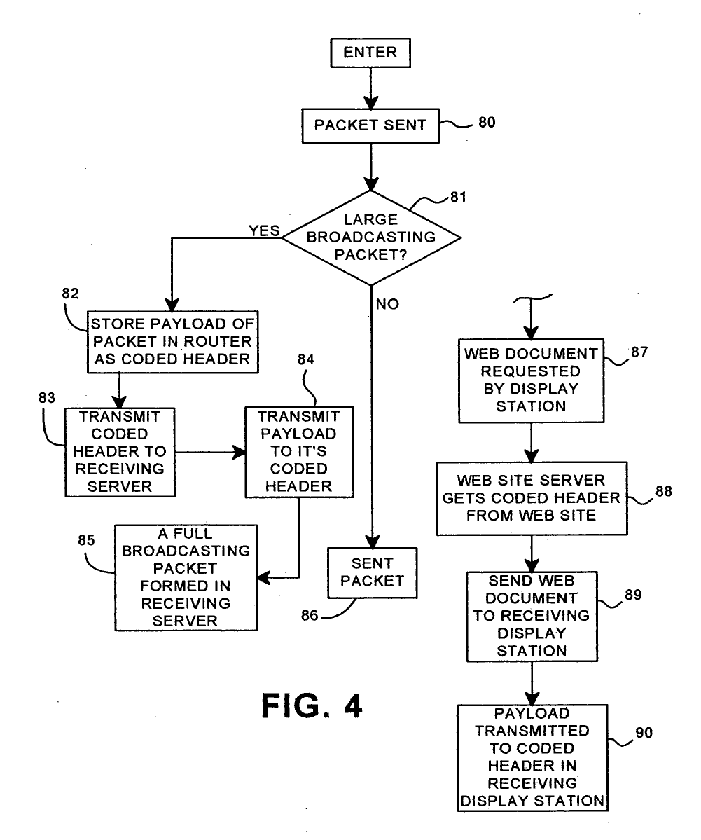

A couple of simplified runs of the process set up in FIG. 3 will now be described with respect to FIG. 4. First, with respect to a packet or broadcasting packet sent from a display station, when the user sends the request, step 80, a determination is made at the service provider as to whether the packet or broadcasting packet is of a size that would get bottlenecked in routers, step 81. If Yes, then the broadcasting payload of the broadcasting packet is temporarily stored in a broadcasting router as a coded header, step 82. The coded header is then transmitted to the receiving server, step 83. The broadcasting payload is transmitted separately to its coded header, step 84. A full broadcasting packet is then formed in the receiving server when the broadcasting payload is relayed to its corresponding coded header according to its address, step 85. If the answer to step 81 is No, then the packet or broadcasting packet is sent to its destination.

In a variation related to requested Web pages, a Web page is requested by a Web station, step 87. An appropriate server at the Web site or Web page source gets the coded header, step 88, and the Web document is sent to the receiving display station, step 89. The broadcasting payload is transmitted to the coded header in the receiving display station to form the full broadcasting packet, step 90.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a communication network with user access via a plurality of data processor controlled interactive display terminals for sending and receiving broadcasting packets, an electronic document distribution system for routing broadcasting packets from a sending server to a receiving server comprising:
means for temporarily coding a broadcasting payload to a set of symbols;
means for temporarily stripping the broadcasting payload from the broadcasting packet;
means for temporarily replacing the broadcasting packet with a coded symbol;
means for adding the coded symbol to a header;
means for transmitting the coded header and a coded payload of the broadcasting packet to the receiving server via the broadcasting router; and
means for converting a corresponding broadcasting payload from its coded format to form a full broadcasting packet in the receiving server.

2. The communication network of claim 1 further comprising means in the document distribution system for reducing the broadcasting payload of the broadcasting packet to a coded header.

3. The communication network of claim 2 further comprising:
means for receiving the coded header and patching the corresponding broadcasting payload from storage to form the full broadcasting packet; and
means for relaying the broadcasting payload to a destination router according to its address.

4. The communication network of claim 3 wherein said document distribution system is an electronic mail distribution system associated with electronic mail sources.

5. The communication network of claim 3 wherein:
said communication network is a distributed network;
said broadcasting payloads are digitized packets;
said document sources are packets; and
said network distribution system is a network server system.

6. In a communication network with user access via a plurality of data processor controlled interactive display terminals for sending and receiving broadcasting packets, a method of distributing transmitted electronic documents routing broadcasting packets from a sending server to a receiving server including the steps of:
coding the broadcasting packet to a set of symbols temporarily;
stripping the broadcasting payload temporarily from the broadcasting packet;
replacing he broadcasting packet temporarily with a coded symbol;
adding the coded symbol to a header;
transmitting a coded header and a coded payload of the broadcasting packet to the receiving server via the broadcasting router; and
converting a corresponding broadcasting payload from its coded format to form a full broadcasting packet in the receiving server.

7. The method of distributing electronic documents of claim 6 further including the step of reducing the broadcasting payload of the broadcasting packet to a coded header.

8. The method of distributing electronic documents of claim 7 further including the steps of:
receiving the coded header and patching the corresponding broadcasting payload from storage to form the full broadcasting packet; and
relaying the broadcasting payload to a destination router according to its address.

9. The method of distributing electronic documents of claim 8 wherein said document distribution system is an electronic mail distribution system associated with electronic mail sources.

10. The method of distributing electronic documents of claim 8 wherein:
said communication network is a distributed network;
said broadcasting payloads are digitized packets;
said document sources are packets; and
said network distribution system is a network server system.

11. A computer program having code recorded on a computer readable medium for distributing electronic documents in a communication network with user access via a plurality of data processor controlled interactive display terminals for sending and receiving broadcasting packets, said program for routing broadcasting packets from a sending server to a receiving server comprising:
means for temporarily coding a broadcasting payload to a set of symbols;
means for temporarily stripping the broadcasting payload from the broadcasting packet;
means for temporarily replacing the broadcasting packet with a coded symbol;
means for adding the coded symbol to a header;
means for transmitting a coded header and a coded payload of the broadcasting packet to the receiving server via the broadcasting router; and
means for converting a corresponding broadcasting payload from its coded format to form a full broadcasting packet in the receiving server.

12. The computer program of claim 11 further including means in the document distribution system for reducing the broadcasting payload of the broadcasting packet to a coded header.

13. The computer program of claim 12 further including:
means for receiving the coded header and patching the corresponding broadcasting payload from storage to form the full broadcasting packet; and
means for relaying the broadcasting payload to a destination router according to its address.

14. The computer program of claim 13 wherein said document distribution system is an electronic mail distribution system associated with electronic mail sources.

15. The computer program of claim 13 wherein:
said communication network is a distributed network;
said broadcasting payloads are digitized packets;
said document sources are packets; and
said network distribution system is a network server system.
